(19) United States
(12) Patent Application Publication
(10) Pub. No.: US 2003/0191691 A1
(43) Pub. Date: Oct. 9, 2003

(54) Computer system for forming a database

(76) Inventor: Mark Nicol Macleod, London (GB)

Correspondence Address: DEMONT & BREYER, LLC, SUITE 250, 100 COMMONS WAY, HOLMDEL, NJ, 07733, US

(21) Appl. No.: 10/408,382

(22) Filed: Apr. 7, 2003

(30) Foreign Application Priority Data
Apr. 6, 2002 (GB) 0208060.4

(51) Int. Cl. G06F 17/60

(52) U.S. Cl. 705/14

(57) ABSTRACT

A computer system that allows a user of the system access to a product or service only when they have been invited by a user already authorized by the computer system. The system storing details of the users of the system allowing links to be made between the users.

### STATEMENT OF RELATED CASES

This case claims priority of Great Britain patent application number GB 0208060.4 filed Apr. 6, 2002.

### FIELD OF THE INVENTION

This invention relates generally to a computer system, method, database or computer readable medium for forming a relational database.

### BACKGROUND

Business methods are well-known devices for promoting products and services comprising advertising, a distribution system and the formation of a database of consumers.

The purchase of databases can be an unreliable and expensive basis for distribution, compiling abstract information on individuals as discrete entities rather than connections in a chain, circle or network of acquaintances, colleagues, friends is and family who might actively promote and disseminate a product by word of mouth, such word of mouth being a powerful form of advertising in its own right. Moreover, mass advertising and market research necessarily rely on high volumes of turnover for their effectiveness and accuracy, and by nature cannot monitor, quantify, qualify or analyze the transmission of the word of mouth on a product or service as it occurs in real time. Furthermore, the proliferation of advertising and unsolicited mail has caused many consumers to ignore advertising sent to them directly and tend to respond more favourably to recommendations made by people whom they already know and trust. In addition, there are certain types of products and services the mass advertising and indiscriminate distribution of which would cause such a product or service to be devalued.

### SUMMARY

The present invention avoids at least some of the problems of the prior art by allowing a user of a computer system access to a product or service only when the user has been invited by a user that is already authorized by the computer system. The system advantageously stores details of the users of the system enabling links to be made between the users.

In some embodiments of the present invention, a database links an authorized user of the product or service with a user who has been invited by the authorized user. The files of the database are stored in a hierarchy whereby the authorized user's files are at a higher hierarchical level than that of the invited user's files.

In some embodiments of the present invention, a computer readable medium having instructions thereon is provided. In conjunction with a computer, the computer readable medium and instructions generate a code for allowing a user to access a product or service, wherein that user may subsequently invite further users to access the product or service.

In some embodiments of the present invention, a computer readable medium having instructions thereon causes a computer to provide a series of web pages that enable a user to enter details, including a code and registration details, in order to access a product or service. Furthermore, the computer readable medium having instructions thereon causes a computer to subsequently invite a further user to access the product or service by sending a communication with a unique code to the invited user.

In some embodiments of the present invention, a computer readable medium having instructions thereon causes a computer to create database files for storing codes generated by the computer and receive details from a user associated with the first code, and to subsequently provide an option to invite further users whereby database files are created that are associated with the first user and that store information related to the invited user.

In some embodiments of the present invention, a method is provided for accessing a product or service on line by using a unique code, and subsequently inviting a further user to access the product or service on line by providing them with a second unique code.

In some embodiments of the present invention, a method is provided for distributing a product or service that directly monitors the dissemination of the word-of-mouth on a product or service and forms a database of the connections between its consumers.

Some embodiments of the present invention provide a business method comprising the means to form a relational database of users of a confidential distribution service for one or more products or services, the database relating the identities of users who are personally known to each other, access to use the distribution service authorized only by personal invitation of an agent of the distribution service or by a registered user thereof, the registered user choosing and providing to the database the identity of one or more potential users, such potential users thereby being authorized to access, become registered users of and invite other potential users to use the distribution service and so on and so forth, the means being provided by the distribution service to authenticate the identities of its users and relate them in the database to the identities of the users by whom they have been invited, a security system being provided by the distribution service to prohibit unauthorized consumers from accessing the distribution service and the products or services it distributes, and prohibit unauthorized distribution of those products or services by tracking the users of those products or services and seeing who invited them and who they invited.

### BRIEF DESCRIPTION OF THE DRAWINGS

Embodiments of the invention will be described with reference to the following figures in which:

FIG. 1 shows a distributing agent giving an authorized invitation in person to a consumer to access a website;

FIG. 2 shows the consumer accessing the website;

FIG. 3 shows the consumer registering his identity and payment details on the website;

FIG. 4 shows the consumer continuing to a menu web page, either directly or after registration or by logging off and subsequently logging on;

FIG. 5 shows the consumer choosing and paying for a product;

FIG. 6 shows the consumer accessing the product and continuing to a menu web page; and

FIG. 7 shows the consumer issuing an email invitation to a consumer of his choosing via the website.

FIG. 8 shows a distributing agent giving an authorized invitation in person to a consumer to access a website;

FIG. 9 shows the consumer registering his name and mobile telephone number on the website;

FIG. 10 shows the consumer calling a premium rate telephone number in order to proceed further on the website;

FIG. 11 shows the consumer accessing the product; and

FIG. 12 show a consumer issuing an authorized invitation by text message via the website to the mobile telephone of a consumer of his choosing.

FIG. 13 shows a distributing agent giving an authorized invitation in person to a consumer to access a website;

FIG. 14 shows the consumer accessing the website, registering his email address for authentication by the distribution service;

FIG. 15 shows the consumer accessing another website which contains the product distributed by the distribution service;

FIG. 16 shows the consumer issuing an authorized invitation by email to another consumer of his choosing and sending a copy of that email to the distribution service; and

FIG. 17 shows the invited consumer accessing the website containing the product.

### DETAILED DESCRIPTION

Referring to FIGS. 1 to 7, the first embodiment of the invention, whereby a relational database of consumers' credit or debit card details is formed, is now described.

Referring to FIG. 1, the database management system 1 of the distribution service controls a database 101 having a number of files. A program for controlling the database management system 1 is loaded from any suitable computer readable medium 102 into the database management system 1. The database management system provides the distributing agent 1C one or more passcodes generated by a passcode dispenser 1A and filed in a file 1B relating to those passcodes distributed by the distributing agent, a different passcode generated for each consumer who receives a passcode from the distributing agent. The distributing agent gives one such passcode, CODE XA, which is associated with the distributing agent, and a Uniform Resource Locator URLX in printed, written or oral form ID to consumer A 2, in person, additionally communicating to Consumer A that the passcode is nontransferable, as shown in FIG. 1.

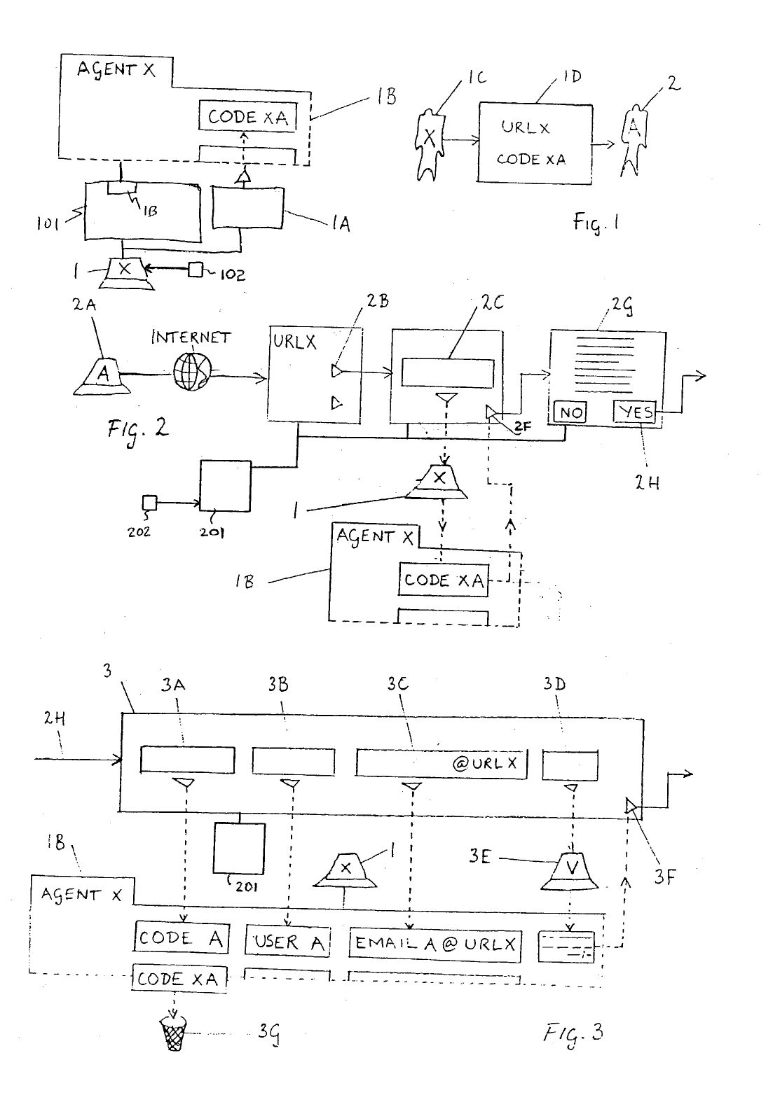

Consumer A, via his computer 2A and Internet browser, accesses the website at URLX. The website is provided by a server 201, which has the website format, page construction and technical features of the website loaded onto it via any suitable computer readable medium 202. Consumer A is prompted to register by clicking link 2B whereupon he is prompted to enter his passcode in text field 2C. If authenticated by the database management system Consumer A is provided access by way of link 2F to a set of legal terms of use 2G to which he must agree by clicking link 2H in order to proceed, as shown in FIG. 2. If the passcode is not found in the database and therefore not authenticated by the database management system the consumer would not be provided the link to proceed further and would be prompted to exit the website (not shown). Similarly, should a consumer not agree to the legal terms of use he would not proceed to register and would be prompted to exit the website (not shown).

Consumer A, in this example, is then provided a registration form 3 in which he is prompted to enter a passcode of his choosing, CODE A in text field 3A which replaces CODE XA in file 1B, CODE XA being disposed of 3G, in order to ensure that the passcode, CODE XA, is used only by its recipient. He is prompted also to choose a user name, USER A, in text field 3B and choose an email address from which authorized invitations to other consumers of his choosing would be sent, EMAILA©URLX, in text field 3C. In text field 3D he is prompted to enter his payment details in the form of a credit or debit card which are sent to an authenticating third party 3E. If authenticated, the details are filed in the database of the distribution service and the link 3F is provided for Consumer A to proceed, as shown in FIG. 3. Alternatively, the details may be stored without subsequent authentication. The option, (not shown) may also be provided for Consumer A to pay a registration fee, the payment transaction being made via his credit or debit card details. If a consumer's card details are not authenticated (not shown), the consumer therefore not being identified by the distribution service the link to access the website further would not be provided, the entries made by the consumer would be deleted from the database and the consumer would be prompted to exit the website.

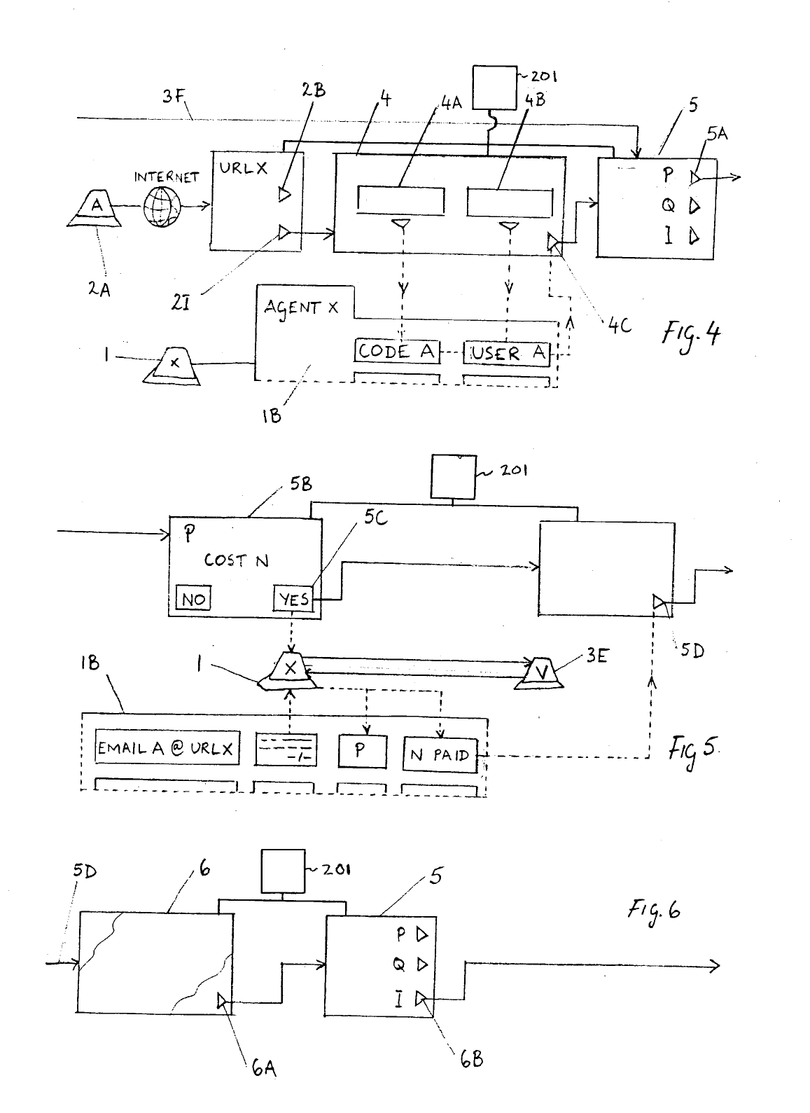

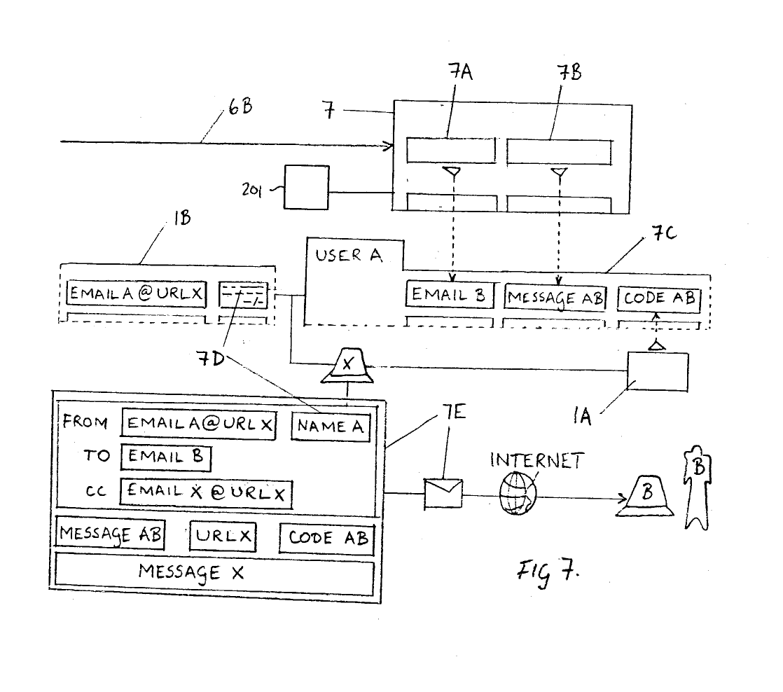

Consumer A, in this example, thus is authorized to proceed to a menu web page 5 either directly by means of link 3F or indirectly, by logging off and subsequently returning to URLX and clicking link 21 taking him to a log on page 4 wherein he is prompted to enter his chosen passcode and user name for authentication, thus providing the link 4C. If a user name and corresponding passcode is not found in the database and therefore not authenticated, the link to the menu web page would not be provided thereby protecting registered users' credit or debit card details. Once at menu web page 5 Consumer A is provided the option to proceed to the products P and or Q and or invite other consumers to register. Consumer A, in this example, chooses to access product P by clicking the link 5A, as shown in FIG. 4.

At web page 5B he is advised of the cost of product P and by clicking the link 5C a payment transaction from Consumer A's credit or debit card is made via the authenticating and authorising third party 3E. Once payment has been authorized, the transaction is filed in file 1B and the database management system provides Consumer A the link 5D to access the product, as shown in FIG. 5. If payment is not authorized, the link 5D would not be provided and a consumer would be prompted to enter details of a different credit or debit card (not shown).

On accessing product P at a web page 6, Consumer A is provided the link 6A to the menu web page 5 wherein he may choose to click the link 5A in order to invite one or more other consumers to register to use the distribution service, by clicking link 6B, as shown in FIG. 6.

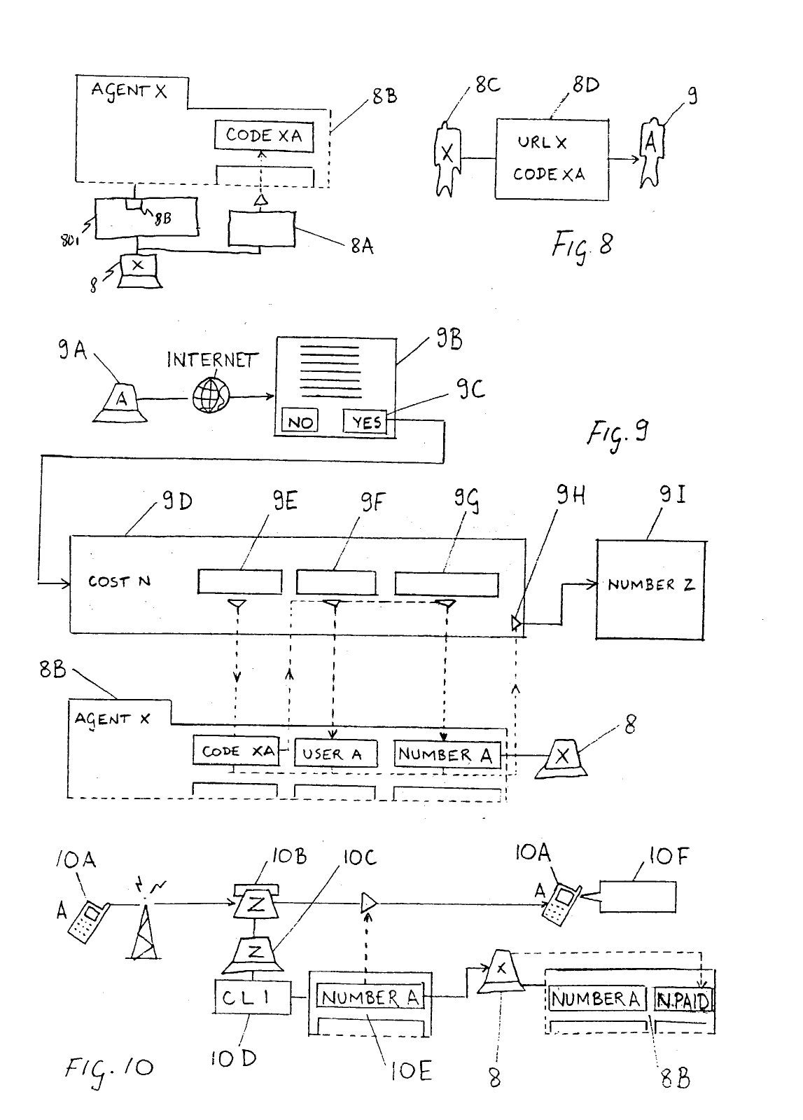

Consumer A then proceeds to an invitation form 7 containing text field 7A in which he is prompted to enter the email address of a person known to him, EMAIL B, and to compose an email message, MESSAGE AB, to be received by that person, EMAIL B and MESSAGE AB being entered into the database of the distribution service in a new file 7C, the file relating to those invited by USER A. File 7C may further contain information associated with the person who invited Consumer A. Into this file is also added a different passcode for each recipient of such invitations, such as CODE AB for the addressee of EMAIL B, Consumer B. The database management system of the distribution service then sends the email 7E to Consumer B, adding the card name of Consumer A 7D, in order for Consumer B to identify the sender, the CC text field entered with the email address of the distribution service in order or advise the recipient that the email has been monitored by the distribution service. URLX and CODE AB are also added to enable Consumer B to access the registration web page of the website. In addition a message composed by the distribution service, MESSAGE X, is added to the email communicating that the passcode is personal to the addressee and non-transferable. Consumer B thus receives the email as shown in FIG. 7 and may therefore register as a user, access the products on the website and or invite other consumers of his choosing, such consumers' identities being entered into a new file, relating to those invited by USER B, those consumers in turn being permitted to register and thus invite others and so on and so forth. The relational database thereby compiled may subsequently be used as the basis for the distribution other products or services which are accessed exclusively via this distribution service and revenue is provided by any registration fees and or sales commission. In addition, the database may be leased or sold to producers at the discretion of the distribution service and its users.

Referring to FIGS. 8 to 12, the second embodiment of the invention, whereby a relational database of consumers' mobile telephone numbers is formed, is now described.

Referring to FIG. 8, the database management system 8 of the distribution service provides the distributing agent 8C one or more passcodes generated by a passcode dispenser 8A and filed in the database of the distributing agent in a file 8B this file relating to those passcodes distributed by the distributing agent, a different passcode generated for each consumer who receives a passcode from the distributing agent. The distributing agent gives one such passcode, CODE XA, and a Uniform Resource Locator URLX in printed, written or oral form to Consumer A 9, in person, additionally communicating to Consumer A that the passcode is non-transferable, as shown in FIG. 8.

Consumer A, via his computer 9A and Internet browser accesses the website at URLX and is prompted to read a set of legal terms 9B to which he must agree by clicking the link 9C in order to proceed. If a consumer does not agree to the legal terms of use he would not be provided a link to proceed further and would be prompted to exit the website (not shown). Consumer A, in this example, is provided a registration form 9D which advertises the cost of the product COST N and he is prompted to enter his passcode in the text field 9E, a user name such as his first name, USER A, in text field 9F and his mobile telephone number, NUMBER A, in text field 9G. If the passcode is authenticated by the database management system, the user name and the first name of Consumer A is filed in file 8B whereupon the link 9H is provided for him to access web page 9I which prompts him to call a premium rate telephone number, NUMBER Z, the cost of such a call being COST N, as shown in FIG. 9. If the passcode is not found in the database and therefore not authenticated the consumer would not be provided the link 9H to proceed (not shown). Consumer A, in this example, from his mobile telephone 10A places the call to NUMBER Z hosted by a premium rate telephone service provider 10B which by way of its computer 10C and Caller Line Identification software 10D identifies the source of the call and sends the identified telephone number, NUMBER A, to the database management system of the distribution service whereupon the entry is made in the appropriate user account, thus registering in file 8B that the call has been placed. Consumer A receives a response by way of a text or voice message 10F advising him that access to the product page is authorized and to await a link to be provided as shown in FIG. 10. If the source of the call can not be identified the call is not answered by the premium rate telephone service provider and thus the link would not be provided.

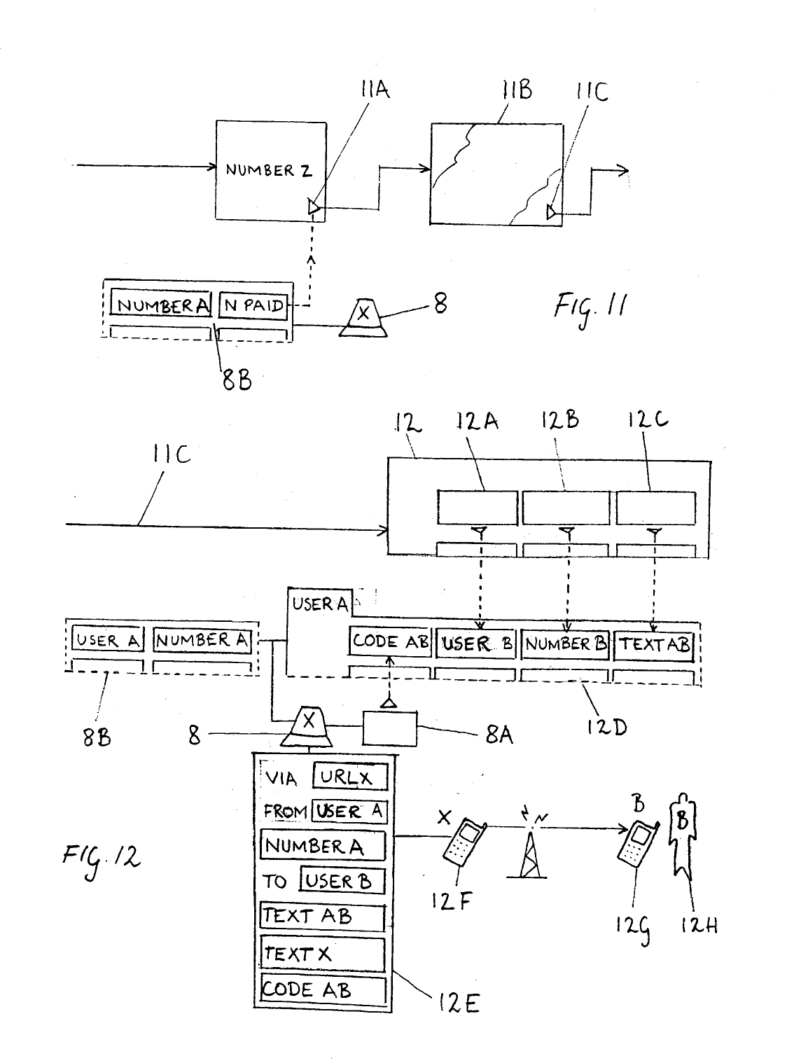

At the website, Consumer A is thus provided the link 11A by the database management system of the distribution service and proceeds to the product web page 11B. On accessing the product he is provided the link 11C in order to proceed to invite other consumers of his choosing to access the product, as shown in FIG. 11. By clicking link 11C Consumer A accesses an invitation form 12 in order to invite one or more other consumers and is prompted to enter the first name of, mobile telephone number of and a text message to be received by such consumers. In this example, Consumer A chooses to invite one such consumer, Consumer B, by entering Consumer B's first name, USER B, in text field 12A, Consumer B's mobile telephone number, NUMBER B, in text field 12B and, by composing a message to be received by Consumer B, TEXT AB, in text field 12C. The database management system of the distribution service files these entries in a new file 12D, the file relating to those invited by USER A. Into this file is also added a different passcode for each recipient of such invitations such as, in this instance, CODE AB for the recipient, Consumer B. The database management system of the distribution service then sends the text message 12E to Consumer B's mobile telephone adding the Uniform Resource Locator URLX, the name of the inviter, USER A, and the mobile telephone number of the inviter, NUMBER A, the name of the recipient, USER B and the message composed by the inviter TEXT AB. Also included in this text message is CODE AB and a text composed by the distribution service, TEXT X, communicating that the passcode is personal to the recipient, non-transferable and provides access to URLX and the product URLX contains. Consumer B, 12H thus receives the text message on his mobile telephone 12G via the database management system's mobile telephone facility 12F, as shown in FIG. 12.

Consumer B may therefore proceed in a similar manner to Consumer A as in FIGS. 9, 10, 11 and 12, but entering his own passcode, first name and mobile telephone number for authentification in the registration page 9D before being authorized to proceed to pay for and access the product and thereby invite other consumers of his choosing, such consumers' names, mobile telephone numbers and messages he composes for them being filed in a new file relating to those invited by USER B who in turn may proceed as did USER B and so on and so forth.

The relational database thereby compiled may subsequently be used as the basis for the distribution other products or services which are accessed exclusively via this distribution service and revenue is provided by a share of the premium rate calls. In addition, the database may be leased or sold to producers at the discretion of the distribution service and its users.

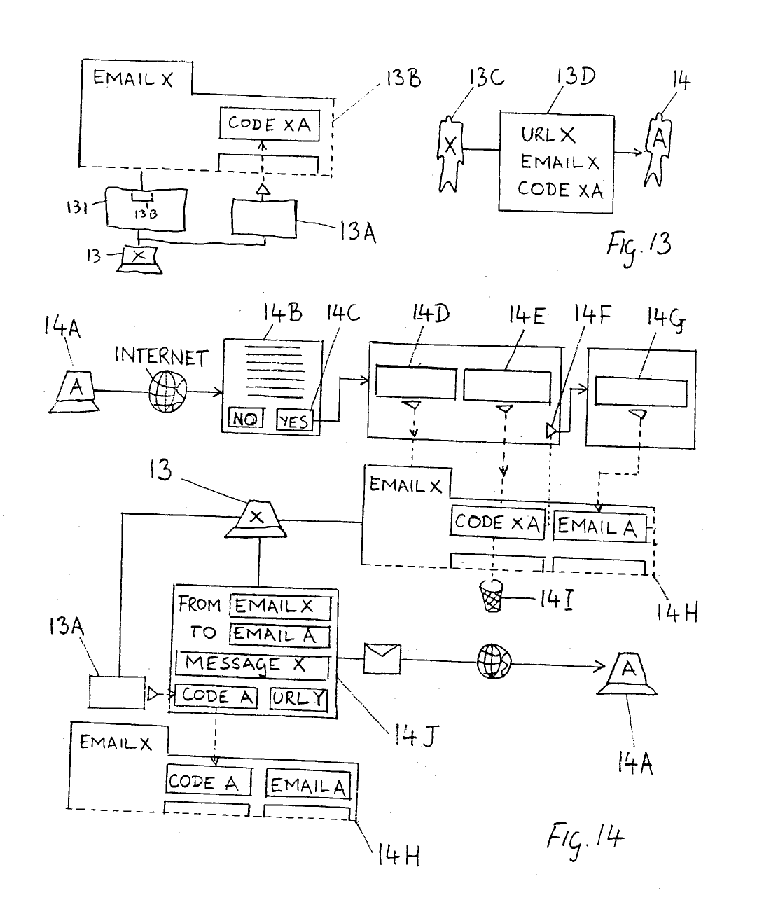

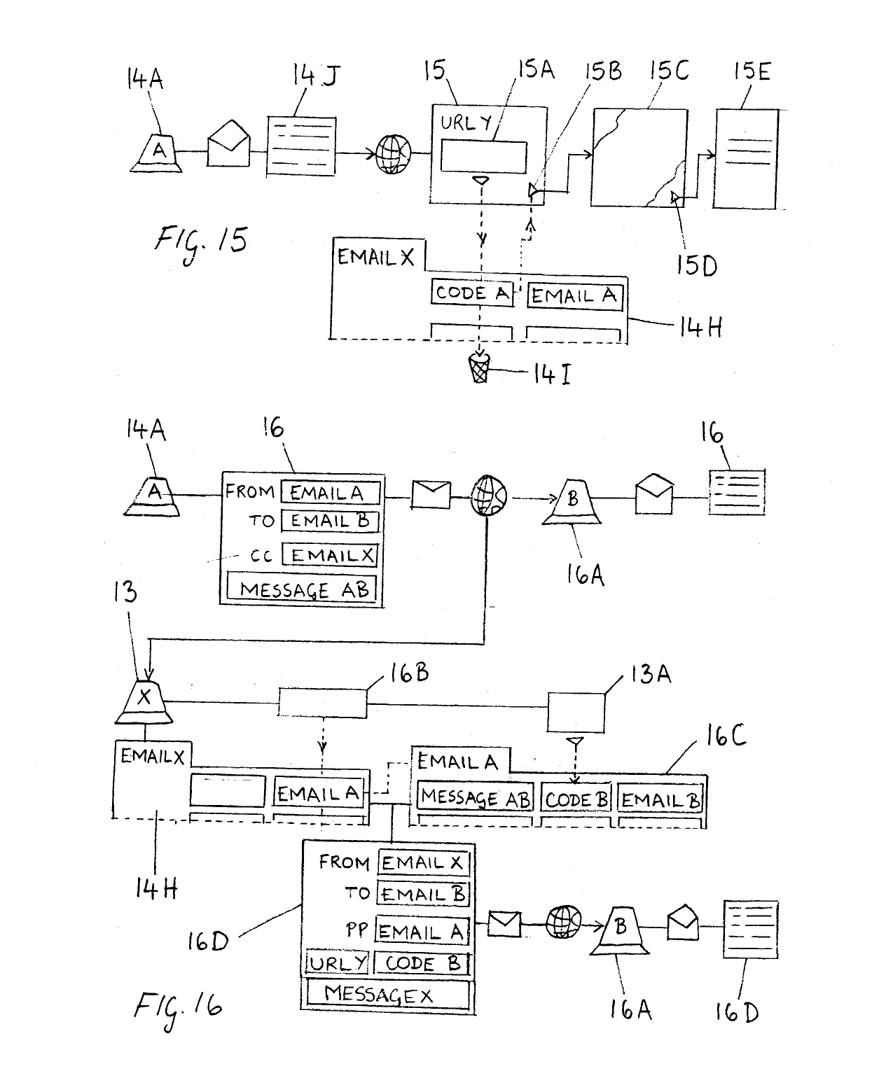

Referring to FIGS. 13 to 17 a third embodiment of the invention, whereby a relational database of consumers' email addresses is formed, will now be described.

Referring to FIG. 13, the database management system 13 of the distribution service provides a distributing agent 13C one or more passcodes generated by a passcode dispenser 13A and filed in the database of the distribution service in a file 13B, the file relating to those passcodes distributed by the distributing agent, a different passcode generated for each consumer who receives a pass code from the distributing agent. The distributing agent gives one such passcode, CODE XA, a Uniform Resource Locator URLX and the email address of the distribution service, EMAIL X, in printed, written or oral form to Consumer A in person 14, additionally communicating to Consumer A that the passcode is non-transferable, as shown in FIG. 13.

Consumer A, via his computer 14A and internet browser accesses the website at URLX and is prompted to read a set of legal terms 14B to which he must agree by clicking the link 14C in order to proceed. If a consumer chooses not to agree to the terms of use he cannot proceed further and is prompted to exit (not shown). Consumer A, in this example, is provided a web page containing text fields 14D and 14E in which he is prompted to enter the email address and passcode that he was given by the distributing agent. If authenticated by the database management system the passcode is disposed of 14I, in order to ensure that this passcode, CODE XA, is used only by its recipient. If the passcode and email address are not authenticated a consumer would be prompted to exit and would not be able to proceed further (not shown). In this example the link 14F is provided to Consumer A to access a page prompting him to enter his email address, EMAIL A, in text field 14G, the email address being filed in file 14H the file relating to those consumers invited in person by the distributing agent. In order to authenticate the email address, the database management system composes an email 143 to be received by Consumer A from the email address EMAIL X, the email containing a new passcode CODE A generated by the passcode dispenser, CODE A entered in the file 14H replacing CODE XA. The email 14J also contains a new Uniform Resource Locator URLY and a message, MESSAGE X, communicating to the recipient that the passcode is personal to the addressee and non-transferable and provides access to the product contained by URLY. The email is then sent to consumer A's email address, EMAIL A, as shown in FIG. 16.

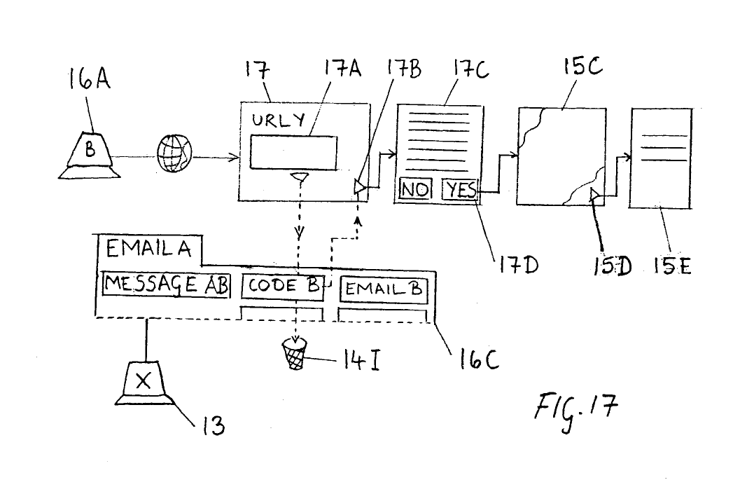

On receipt of this email Consumer A accesses the website at URLY via the internet where he is provided a web page 15 prompting him to enter his passcode in text field 15A. If the passcode is authenticated by the database management system CODE A disposed of in order to ensure the passcode provides only one access to the product, and the link 15B is provided for Consumer A to access the product 15C. On accessing the product he is provided the link 15D to web page ISE wherein he is given instructions on how to invite one or more other consumers of his choosing as shown in FIG. 15. Consumer A follows these instructions and chooses, in this example, to invite one person known to him, Consumer B, by composing a message MESSAGE AB to be sent from his own email address EMAIL A to the email address of Consumer B, EMAIL B, a copy also being sent to the email address of the distribution service, by entering EMAIL X in the CC text field of his email composition window. Thus the email 16 is sent to Consumer B and the distribution service simultaneously. On receipt of the copy of the email the database management system identifies the sender by means of a route tracing program 16B and if authenticated, opens a new file 16C relating to those invited by the addressee of EMAIL A. Into this file is entered the email address of the recipient of the invitation, EMAIL B and the message composed by Consumer A, MESSAGE AB. A new passcode CODE B for use by Consumer B is provided by the passcode dispenser and entered in the file. The database management system then composes an email from EMAIL X to Consumer B's email address EMAIL B. In order for the recipient of the email to authenticate that the email has been sent on behalf of Consumer A, Consumer A's email address, EMAIL A, is provided in the email. Also included in this email is the Uniform Resource Locator URLY and the passcode, CODE B, to access the product contained by the website at URLY and a message, MESSAGE X, communicating to the recipient that the passcode is personal to the addressee and non-transferable. The database management system then sends this email to Consumer B who opens it and reads it as shown in FIG. 16.

Consumer B thus proceeds via the internet to URLY, the web page 17 prompting him to enter his passcode to be authenticated by the database management system. If authenticated the passcode is disposed of 14I, in order to ensure that the passcode provides only one access to the product. The database management system, identifying that Consumer B has not yet read the legal terms of use 17C provides the link 17B to them. Agreeing to the terms of use by clicking link 17D, Consumer B accesses the product 15C thereafter being provided the link 15D to web page 15E wherein he is given instructions as how to invite other consumers of his choosing, as shown in FIG. 17. If a passcode is not authenticated and or a consumer does not agree to the legal terms of use the consumer would not be able to proceed to the product and would be prompted to exit the website (not shown).

Consumer B, in this example, may proceed as did Consumer A as shown in FIG. 16 inviting one or more other consumers, by sending copies of his invitations to the email address of the database management system, a new file relating to those invited by Consumer B being opened and passcodes sent to the consumers to access the product contained in URLY and thus send invitations of their own and so on and so forth. In the absence of any payment being made by consumers in this embodiment of the invention, the distribution service and the producer of the product provide the product as a loss-leader in order to form an initial database. Revenue may also be gained by leasing or selling such a database to other producers.

An embodiment of the legal terms of use as referred to in FIGS. 2G, 9B, 14B and 17C of the accompanying drawings, will now be described by way of example only.

The terms of use of the distribution service:

You, the user, agree to keep all information provided by or via the distribution service strictly confidential. You understand that a breach of this confidentiality agreement could in extreme circumstances result in civil liabilities.

You understand that you may only access the products and services via the distribution service and not directly from the producers of those products and services themselves.

You acknowledge that this distribution service is by personal invitation only. You accept that you are not permitted to use this service unless you have been invited by a distributing agent or a registered user.

You understand that the distribution service permits you to invite individuals whom you trust to access the distribution service. You permit the distribution service to pass on to those individuals, on your behalf, the means to access the products or services provided by the distribution service.

You understand that to receive the products or services provided by or via the distribution service, you may be required to provide proof of your identity and the means for the distribution service to identify the individual by whom you have been invited.

You permit the distribution service to use your personal details to send you information about the products or services provided via the distribution service or about the distribution service itself.

It will be clear that the form of the messages sent by the user inviting a subsequent user to use a product or service may be in a form other than a text message. For example, the message may be in the form of a photo message or video message.

It will be clear that the product or service being supplied may be available online or via an online service. For example, the product or service may be a charity fund raising scheme, a supplier of e.books, music or videos or a tipster for gambling purposes. Also the product or service may only be available in a non-electronic form.

It will be understood that embodiments of the invention are described herein by way of example only, and that modifications may be made without departing from the scope of the invention.

I claim:

1. A computer system comprising a data input device, a database incorporating database files, a database management system for controlling the database, a registration device, a code generation device, a product or service access device, an invitation device and a communication device;
the computer system having one or more codes generated by the code generation device, the codes stored in one or more database files created by the database management system;
the data input device being arranged to receive a first code input by a first user of the computer system;
the database management system being arranged to locate the database file associated with the first code;
the registration device being arranged to receive details of the first user of the computer system and provide these details to the database management system so they are stored in the database file associated with the first code;
the product or service access device being arranged to provide the first user of the computer system access to a product or service only if the database file associated with the first code is located;
the invitation device being arranged to provide an option for the first user to invite additional users to use the product or service, and when the invitation device detects the option has been selected and receives, from the first user, contact information associated with the additional user, the database management system being further arranged to create a further database file associated with the first user and to store the contact information associated with the additional user in the further database file;
the database management system being further arranged to create a message for the additional user, the message containing data retrieved from both the database file associated with the first code and the further database file;
the code generation device being arranged to generate an additional code for inclusion in the message, the additional code generated being associated with the additional user; and
the communication device being arranged to send the message to the additional user.

2. The computer system according to claim 1 wherein the data input device is further arranged to receive a second code entered by the first user, the database management system being further arranged to replace the first code with the second code by deleting the first code and storing the second code in the database file associated with the first code.

3. The computer system according to claim 1 further comprising a verification device wherein the verification device is arranged to verify payment details of the first user of the computer system.

4. The computer system according to claim 1 wherein the details of a first user received by the registration device includes any one of the following: name of user; e-mail address of the user; mobile telephone number of the user.

5. The computer system according to claim 1 wherein the communication device is a mobile telephone system.

6. The computer system according to claim 1 wherein the communication device is an e-mail server.

7. The computer system according to claim 1 wherein the message is in the form of a mobile telephone message.

8. The computer system according to claim 1 wherein the message is in the form of an e-mail.

9. The computer system according to claim 1 wherein the contact information is in the form of a telephone number.

10. The computer system according to claim 1 wherein the contact information is in the form of an e-mail address.

11. A method of operating a computer system having a data input device, a database incorporating database files, and a communication device, the method comprising;
generating one or more codes and creating at least one database file for storing the one or more codes;
receiving a first code via the data input device, the first code input to the data input means by a first user of the computer system;
locating the database file associated with the first code receiving details of the first user using the registration device and storing these details in the database file associated with the first code;
providing the first user access to a product or service only if the database file associated with the first code is located;
providing an option for the first user to invite additional users to use the product or service, and, upon the first user selecting said option and providing contact information associated with the additional user;
creating a further database file associated with the first user and storing the contact information associated with the additional user in the further database file; and
creating a message for the additional user using data retrieved from both the database file associated with the first code and the further database file, the message further including an additional code, the additional code being associated with the additional user, and the message being sent via the communication means.

12. The method according to claim 11 further comprising the step of receiving a second code entered by the first user using the data input device, and replacing the first code with the second code by deleting the first code and storing the second code in the database file associated with the first code.

13. The method according to claim 11 further comprising the step of verifying payment details of the first user of the computer system.

14. The method according to claim 11 wherein the received details of a first user include any one of the following: name of user; e-mail address of the user; mobile telephone number of the user.

15. The method according to claim 11 wherein the communication device is an e-mail server.

16. The method according to claim 11 wherein the communication means is a mobile telephone system.

17. The method according to claim 11 wherein the message is in the form of an e-mail.

18. The method according to claim 11 wherein the message is in the form of a mobile telephone message.

19. The method according to claim 11 wherein the contact information is in the form of an e-mail address.

20. The method according to claim 11 wherein the contact information is in the form of a mobile telephone number.

21. A method of gaining access to a product or service online and subsequently inviting a further user to gain access to the product or service, the method comprising the steps of;
receiving a first unique code and online access information from an authorized user of the product or service;
going online and entering the code provided by the authorized user;
registering by providing a user name;
providing a second unique code to a further user via a communication means, such that the further user can then access the product or service.

22. The method according to claim 21 further comprising the step of agreeing to a list of terms of use of the product or service.

23. The method according to claim 21 wherein the product or service are available via the Internet and the online access information provides access to a website.

24. The method according to claim 21 wherein the first unique code and online access information is provided by the authorized user through either word of mouth or by manually receiving the code and address via a written medium.

25. The method according to claim 21 further comprising the step of providing payment details to the website such that upon verification of payment details, access to the product or service is provided by a link being activated on the website.

26. The method according to claim 25 further comprising the step of providing a mobile telephone number in order to extract payment from the mobile telephone account, thereby allowing access to the product or service.

27. The method according to claim 21 wherein the communication means is a mobile telephone system.

28. The method according to claim 21 wherein the communication means is an e-mail server.

29. The method according to claim 21 wherein the first unique code provides access to the product or service only once.

30. The method according to claim 21 wherein the first unique code provides access to the product or service more than once.

31. A database for linking an authorized user of a product or service with an invited user of a product or service, and for storing data associated with the invited user, the authorized user having invited the invited user to access the product or service, the database having;
a first set of files at a first hierarchical level associated with the authorized user;
the first set of files having data stored therein that is associated with the invited user;
the data associated with the invited user being stored in the first set of files upon the invited user registering to use the product or service;
the data associated with the invited user including a first unique code allowing the invited user to access the product or service;
a second set of files created when the invited user invites a further user to access the product or service, the second set of files being associated with the invited user who invited the further user;
the second set of files at a hierarchical level lower than the first hierarchical level;
the data associated with the further user being stored in the second set of files upon the further user registering to use the product or service;
the data associated with the further user including a second unique code allowing the further user to access the product or service;
each of the first and second sets of files containing data allowing a link to be established between them.

32. A computer readable medium having instructions thereon which, when loaded into and executed by a computer, causes the computer to display a series of webpages, the first of said series of webpages having;
a code verification means for verifying an entered code, which upon verification causes the computer to display;
a webpage indicating the terms of use of subsequent webpages, which upon acceptance causes the computer to display;
a registration page for entering a new code to replace the entered code, for providing a user name and for providing payment details, and upon verification of payment details causes the computer to display;
a product or service selection webpage for choosing a product or service and upon selection of a product or service causes the computer to display;
a payment acceptance webpage indicating the cost of the product or service, and upon acceptance of the payment causes the computer to display;
a product or service webpage providing said product or service;
said product or service selection webpage further including an option to invite further users to access the webpages, which upon selecting the invite option causes the computer to display;
an invitation form for supplying contact information of the invited user, which upon entering causes the computer to send a communication to a database management system in order for a message to be sent to the invited user informing them that they have been invited to use said product or service and provide them with a unique code for accessing the product or service.

33. A computer readable medium having instructions thereon which, when loaded into and executed by a computer, causes the computer to;
generate one or more codes and create at least one database file for storing the one or more codes;
receive a first code via, the first code input by a first user of the computer;
locate the database file associated with the first code;
receive details of the first user and store these details in the database file associated with the first code;
provide the first user access to a product or service only if the database file associated with the first code is located;
provide an option for the first user to invite additional users to use the product or service, and, upon the first user selecting said option and providing contact information associated with the additional user;
create a further database file associated with the first user and store the contact information associated with the additional user in the further database file;
create a message for the additional user using data retrieved from both the database file associated with the first code and the further database file, the message further including an additional code, the additional code being associated with the additional user; and
send the message to the additional user.
